(19) United States
(12) Patent Application Publication
(10) Pub. No.: US 2020/0164452 A1
(43) Pub. Date: May 28, 2020

(54) METHOD OF JOINING A NIOBIUM TITANIUM ALLOY BY USING AN ACTIVE SOLDER

(71) Applicant: Oxford Instruments Nanotechnology Tools Limited, Oxon (GB)

(72) Inventors: Dieter Jedamzik, Oxon (GB); Alvin Adams, Oxon (GB)

(21) Appl. No.: 16/612,884

(22) PCT Filed: May 11, 2018
(86) PCT No.: PCT/GB2018/051287

§ 371 Date: Nov. 12, 2019

(30) Foreign Application Priority Data
May 12, 2017 (GB) 1707676.1

(51) Int. Cl. B23K 1/00; H01B 1/02; B23K 1/06; B23K 1/19; B23K 1/20; H01B 12/02; B23K 101/38; B23K 35/26; B23K 103/14; B23K 103/18

(52) U.S. Cl. CPC B23K 1/0016; H01B 1/02; B23K 1/06; B23K 1/19; B23K 2103/18; H01B 12/02; B23K 2101/38; B23K 35/262; B23K 2103/14; B23K 1/20

(57) ABSTRACT

There is provided a method of joining a first member made of a niobium titanium alloy to a second member. The method comprises abutting a respective surface of each of the first member and the second member together to form an interface therebetween; providing a molten active solder at a surface of at least the first member at the interface and thermally activating the molten active solder; mechanically agitating the molten active solder so as to cause the molten solder to adhere to the first and second members and form a continuous body of molten solder linking the first and second; and causing the continuous body to solidify thereby forming a solder joint between the first and second members.

### FIELD OF THE INVENTION

The present invention relates to a method of joining a member made of a niobium titanium alloy to another member using an active solder. This is with the intent that the resulting solder joint is used in cryogenic applications.

### BACKGROUND

In cryogenic applications joints between superconductors or superconductors and “normal” metals (i.e. non-superconducting metal or metal alloy) are often required. The superconducting material used for the superconductors is often a metal or metal alloy. The superconducting material is able to be used in a number in different forms, including plates, sheets, ribbons, wires, tubes or coaxial cables. Examples applications in which superconductors are used include magnets, high current conductors, electromagnetic screening and signal transmission.

As an example of signal transmission, in cryogenic refrigerators, such as dilution refrigerators, data needs to be transferred between a cooling target and an exterior of the refrigerator. As such, cabling is used to provide a data transfer capability between the cooling target and the refrigerator exterior.

Such refrigerators typically have a number of stages or levels to their physical structure. When not in use, all the levels are at the same temperature, ambient temperature, but when in use the temperature differs from level to level with the temperature decreasing the closer the level is to the cooling target. Accordingly, there is temperature cycling within the refrigerator as it is cooled for use and then allowed to warm after use.

To minimise the heat loss between the ambient environment and a cooling target, signal transmission cables between the cooling target and the ambient environment at room temperature will be thermally anchored at every stage of the refrigerator. For some applications attenuators or other devices might be inserted at different levels of the refrigerator.

Additionally, because the temperature between levels differs and different materials may be used, for example, for structural elements and semi-rigid cabling, stress is caused between the different materials due to the respective differing amounts of thermal expansion. As well as the stress in the structural elements, thermal expansion also causes stress in any ‘filler’ material of a joint, such as solder alloy.

Therefore, due to the stage/level structure of such refrigerators, and the need for a data transfer line to reach thermal equilibrium with the components with which it interacts (commonly referred to as “thermalisation”), it is uncommon to have a single cable providing a data transfer line between the cooling target and refrigerator exterior. Instead, there are multiple cables that provide a data transfer line with each cable being thermally anchored to the next at an interface between adjacent stages/levels. Typically, the cables are coaxial cables for the transmission of high frequency signals.

Each coaxial cable is terminated with a coaxial connector on each end to form a coax-assembly. At the interface between stages/levels, each coax-assembly is connected to a bulkhead adaptor with or without an attenuator to thermalize the data transfer line.

So that a data signal can reliably pass from one coaxial cable to the next, a solder joint is formed between the coaxial cable and the coaxial connector as part of the connection between the cable and connector during manufacture of the coax-assembly. Solder joints are also used because they form a strong, robust connection between the cable and connector, which is beneficial because stresses are caused by the thermal contraction mismatch between different materials as well as vibrations in the refrigerator. Solder joints also offer good thermal and electrical properties and have low loss of reflected/returned signal power due to discontinuities in the transmission lines (commonly referred to as “return loss”).

Depending on the material of the coaxial cables in the signal line, signal strength can be attenuated. Further decrease in signal strength can be caused by inserting Radio Frequency (RF) attenuators along the data transmission line. The total attenuation is commonly referred to as “insertion loss”.

To reduce insertion loss, the signal carrying portions of the coaxial cables in the stages closest to the cooling target are made from a niobium titanium alloy. This is because, typically, these stages are the stages at which the local temperature is less than 4 Kelvin (K) when the refrigerator is in use and niobium titanium alloys are superconducting at these temperatures (the critical temperature (T_{c}) of niobium titanium is about 9.3 K). When superconducting, the transmission losses of niobium titanium coaxial cables are dramatically reduced while at the same time the thermal conductivity of the line remains low, minimising heat loss. Therefore the properties of the niobium titanium alloy are a great advantage over normal metal (i.e. non-superconducting metal or metal alloy) equivalents.

However, the use of a niobium titanium alloy in the coaxial cables causes problems with the solder joint between the coaxial cable and the connector. This is because the niobium titanium alloy has a surface oxide which is difficult to wet using solder alloys, even when aggressive flux is applied to remove the oxide. Therefore, the joints fail significantly more than solder joints formed between coaxial cables made of non-niobium titanium alloys and the connectors. Since it is not practical to use an alternative material for the coaxial cable due to the need to keep insertion loss to a minimum while minimizing thermal conduction, an alternative means of connecting the cable to the connector is required.

When developing the present invention a number of possible alternative approaches were assessed. One such alternative approach was to electroplate the coaxial cable made of a niobium titanium alloy with a nickel or gold layer so that the nickel/gold layer could then be soldered to the connector. However, we found that this approach was unsuitable because the joint between the nickel layer and the niobium titanium layer failed causing the whole joint to fail.

Two further approaches were also tested. The first was a hybrid process based on crimping a sleeve of copper and tubes made of a beryllium-copper alloy to the coaxial cable and then soldering the beryllium-copper alloy tube (as the outer layer on the coaxial cable) to a gold plated beryllium-copper alloy connector. This improved the joint strength over the previous methods. However, the joint was still showing low tensile strength and therefore unreliable due to the risk of the joint failing.

The second further approach was a standard crimp joint. This involved placing a connector around bare wire of the coaxial cable and compressing the connector so that it deforms and grips the wire making electrical contact. A collet on the end of the connector was then placed over the coaxial cable with electrical contact being established by means of tightening a nut over the collet. This technique works well at room temperature but is less suitable for applications where the connector has to work over a wide temperature range, including at temperatures as low as 4 K.

So that the crimp joint forms a suitable physical joint as well as an electrically conductive joint, for example for electro-magnetic screening applications, the connector part of the crimp joint is also placed around the outer sleeve of the coaxial cable. However, the compression that is applied to the connector to deform it around the outer sleeve causes the cable to deform and changes the diameter of the dielectric of the coaxial cable. Any variation of the dielectric diameter along the length of the coaxial cable causes deterioration in the RF properties along with other properties of the cable, which is detrimental to the performance of the cable.

A further issue with using crimp joints is due to their bulky size and reliability. There is an increasing need for additional data transmission lines in dilution refrigerators, meaning that more coaxial cables are needed. This is because the applications for which dilution refrigerators are being used are extending into quantum computing and other applications that produce significant quantities of data. Due to the limited space and desired high density of the connectors, cable and connector diameters need to be decreased to minimise the footprint of the connector system and the heat load resulting from the coax-assembly. The reduced size of the coaxial cables and larger connector footprint makes crimp joints less desirable.

Other joining techniques more similar to soldering than crimping, such as brazing or welding, are also unsuitable because the temperatures required for such techniques would cause the non-metal parts (for example, the dielectric) of the coaxial cable to break down.

The issues with these joints centre on the need to use niobium titanium alloys. These are unsuitable for known soldering techniques and solder joints. However, known alternatives to soldering also do not provide suitable reliability or have a detrimental effect on performance. Thus, a reliable joint and method of forming a joint between a member made of a niobium titanium alloy and another member is needed.

### SUMMARY OF INVENTION

According to a first aspect of the invention, there is provided a method of joining a first member made of a niobium titanium alloy to a second member, abutting a respective surface of each of the first member and the second member together to form an interface therebetween; providing a molten active solder at a surface of at least the first member at the interface and thermally activating the molten active solder; mechanically agitating the molten active solder so as to cause the molten solder to adhere to the first and second members and form a continuous body of molten solder linking the first and second; and causing the continuous body to solidify thereby forming a solder joint between the first and second members.

We have found that the solder joint produced by this method has a higher reliability than previous solder joints and crimp joints. This is because we have found that the solder joint produced between the first member and second member has a tensile strength between three and five times greater than known solder and crimping joints both at room temperature, and at about 77 K. Additionally, since active solders do not require a flux, the solder joint is able to be produced in a fluxless process. This means that the solder joint will have a lower failure rate than solder joints produced using processes that are reliant on flux because flux residue left by these processes has an aggressive chemical nature that corrodes the solder joint produced and the adjacent area because it cannot easily be washed off. An example where it is not possible to wash off flux is in blind joints where it is not possible to visualise all or part of the joint. The corrosive effect is particularly prevalent when the joint is exposed to humidity. However, even when aggressive flux is used, niobium titanium alloy cannot be wetted.

Furthermore, the physical dimensions of the first and second member are not affected by the soldering process as they would be if a crimping process was implemented. This allows the electrical and RF properties to be left un-damaged. Additionally, the solder joint has been found to have improved responses to thermal cycling and thermal mismatch between components thereby reducing the failure rate of such a solder joint.

In addition, by using solder, the temperatures used during the process are lower than are used in welding or brazing for example. This limits the potential of causing damage to other components in thermal contact with the first and second members or that come into contact with the solder itself. This means that the joint is made by relying on a chemical reaction to breakdown any oxides present on a surface of each of the first and second member and relying on van der Waals forces to form a joint instead of causing the one or both members to (partially) melt to form a joint, as would be the case for welding, or by burning through or melting an oxide layer as would be the case in brazing. This therefore makes soldering a less aggressive process that limits degradation of the members being joined thereby preserving the original form of the members being joined allowing the original properties to be maintained or at least to be less affected by the process of forming a joint than would otherwise be the case.

The method set out above uses active soldering. By the term “active soldering” we intend to mean a combination of processes that allow substrates that readily form surface oxides, such as niobium titanium alloys, to be wetted by a solder alloy. This can include the steps of thermally activation to bring the solder alloy to a reaction temperature; chemical reaction of the solder alloy with the surface oxide of a target substrate; and agitation of the surface of the liquid active solder to break up any oxide skin (also referred to as a “dross”) floating on the surface of the liquid active solder though the use of ultrasonic of mechanical devices. The reaction temperature of the solder may be considered as a temperature where at least one of the components of the solder is able to react with components external to the solder. The chemical reactions are able to be achieved through the inclusion of at least one of titanium, cerium, gallium and magnesium in the solder alloy since these allow a reaction to be initiated. The break-up of the dross caused by the agitation exposes the surface of the substrate to un-oxidised solder alloy thereby allowing the substrate surface to be wetted by the solder alloy.

The processes used for conventional solders (i.e. solders that are not “active” solders) use separate chemical fluxes or have chemical fluxes incorporated into the solder. These fluxes are not conventionally part of the solder alloy composition and are not needed in active soldering to break down the surface oxides on a substrate. Indeed, using a soldering technique that uses a flux instead of an active soldering process is insufficient to allow a niobium titanium alloy to be wetted by a solder.

There are at least two alternative ways to apply the method according to the first aspect. In a first alternative, typically the molten active solder is provided at the surface of at least the first member and thermally activated before the respective surfaces of each of the first and second member are abutted together, the thermally activated molten solder being mechanical agitated at the surface of the first member so as to cause the active solder to adhere to the surface of the first member thereby providing a coated surface of the first member.

The first alternative provides a two-stage process for forming a solder joint between the first member and the second member. This allows each of the first member and second member to be prepared separately allowing precision application of solder to each member.

In a second alternative, typically the providing of the molten active solder and thermally activating the molten active solder at the surface of at least the first member is performed after the respective surfaces of each of the first member and second member are abutted together thereby providing the molten active solder and thermal activation of the molten active solder at the interface of the first and second members.

The second alternative provides a one-stage process for forming a solder joint between the first member and second member. Accordingly, this makes the process more suitable for mass production since all the components are simultaneously present at a single location making the application of the solder and heating of the solder more simple than a process with more stages and therefore reduces the time taken to conduct the process.

Preferably, the first and second members are each heated before the molten active solder is provided at the surface of at least the first member. This allows the molten active solder to flow more easily over the first and second members and reduces the amount of heat conducted away from the location at which the molten active solder is provided.

According to a second aspect of the invention, there is provided a method of joining a first member made of a niobium titanium alloy to a second member, the method comprising: providing a thermally activated molten active solder at a surface of the first member and mechanically agitating the thermally activated active solder so as to cause the active solder to adhere to the surface of first member thereby providing a coated surface of the first member; abutting the first member and the second member together and mechanically agitating the molten active solder causing the molten active solder to adhere to a surface of the second member so as to form a continuous body of molten solder linking the surfaces of the first and second members; and causing the continuous body to solidify thereby forming a solder joint between the first and second members. This corresponds to the first alternative described above. As such this has the same benefits as the first alternative.

According to the first alternative or the second aspect, the molten active solder may be kept molten once coated on the surface of the first member. Typically though, the process further comprises causing the molten active solder to solidify between providing the coated surface of the first member and abutting the respective surfaces of each of the first and second members, and re-melting the active solder after abutting said respective surfaces. Once the molten active solder solidifies, this provides a tinned niobium titanium alloy surface protected from oxidisation. This allows the first member to be prepared for joining to the second member at a different time and/or a separate location meaning that different steps of the process can be carried out by different parties, such as by a supplier as well as the producer of the joints. Additionally, causing the solder to solidify between when it is coated on to the first member and joined to the second member reduces the likelihood of contamination of the solder during the intervening period.

It is possible to only use the solder that is coated on the surface of the first member to form the solder joint between the first and second members. However, there are occasions when more solder may be needed. Accordingly, further molten active solder may be provided at the respective surfaces of the first and second members when said surfaces are abutted. This allows a suitable solder joint to be formed when there is not enough fresh, active solder coated on the surface of the first member to provide such a solder joint.

The surface of the second member (that is abutted with the coated surface of the first member) may simply be abutted against the coated surface of the first member without any pre-treatment. Typically however, the method further comprises providing molten active solder at the surface of the second member and mechanically agitating the molten solder so as to cause the solder to adhere to the surface of second member thereby providing a coated surface of the second member. This may be in addition to, or as an alternative to providing further molten solder at the respective surfaces of the first and second members when said surfaces are abutted. This provides additional solder that can be used to form the solder joint and allows the surface of the second member to be coated before it is abutted with the surface of the first member. This makes the solder joint more reliable since each of the first and second members are pre-coated with solder thereby each having a good connection with the solder before the two members are joined.

As mentioned above, typically, the molten solder provided at the surface of the second member is an active solder, and providing molten solder at the surface of the second member then further comprising mechanically agitating the molten solder, the mechanical agitation causing the active solder to adhere to the surface. However, if the surface of the second member is pre-tinned by a non-active solder and a flux is used to facilitate the wetting of the surface, any potential flux residue (including any residue left by so called “no clean” fluxes) used to create this joint has to be removed before the two tinned surfaces are abutted. In contrast, by using an active solder to coat the second member, flux is not needed when the second member is made of a suitable material, so there will be no flux residue to be removed, which makes the joining of the first and second members more efficient.

As an alternative to or before providing a molten active solder at the surface of the second member so as to cause the solder to adhere to the surface of second member thereby providing a coated surface of the second member, the method may further comprise coating a surface of the second member with tin or a tin solder alloy. Once the tin or tin solder alloy is coated on to a surface of the second member this forms a “tinned” surface. The coating may be achieved by electroplating the surface of the second member with tin or tin solder alloy so as to cause the tin or tin solder alloy to adhere to the surface of the second member or by providing molten tin or tin solder alloy at the surface of the second member so as to cause tin or tin solder alloy to adhere to the surface of the second member. This allows the surface of the second member to be pre-tinned (i.e. tinned with tin or tin solder alloy by a fluxless process allowing a fluxless coating to be applied to the surface of the second member. Any non-flux based process of coating a surface of the second member with tin or tin solder alloy may be applied as a further alternative.

The active solder provided as molten solder at the surface of the second member may be an alternative active solder to that used to coat the surface of the first member. Typically however, the active solder provided as molten solder at the surface of the second member is the same active solder as the active solder coated on the surface of the first member. This means that the solder coating on the surface of each of the first member and second member will be completely compatible with the solder coating on the respective other member. This avoids the solder joint being weakened through any incompatibility between the solders coated on the respective surface of the first and second members.

The molten solder coated on the surface of the second member may be kept molten once coated on the surface of the second member. Typically though, the method further comprises causing the molten solder provided at the surface of the second member to solidify between the step of providing the coated surface of the second member and the step of abutting the respective surfaces of each of the first and second members, and re-melting the second solder after abutting said respective surfaces. This has the same benefits as solidifying the molten solder coated on the surface of the first member before abutting the respective surfaces of the first and second members together. Accordingly, these benefits are that it allows the second member to be prepared for joining to the first member at different time and/or a separate location meaning that the process can be carried out by different parties, such as by a supplier as well as the producer of the joints. Additionally, causing the solder to solidify between when it is coated on to the second member and joined to the first member reduces the likelihood of contamination of the solder during that period.

According to a third aspect of the invention, there is provided a method of joining a first member made of a niobium titanium alloy to a second member, the method comprising: abutting the first member and the second member together to form an interface therebetween; providing a molten active solder at the interface of the first and second members and thermally activating the molten active solder; mechanically agitating the thermally activated molten active solder causing the molten solder to adhere to the first and second members and form a continuous body of molten solder linking the first and second members; and causing the continuous body to solidify thereby forming a solder joint between the first and second members. This corresponds to the second alternative described above. As such this has the same benefits as the second alternative.

In relation to the first aspect, first alternative, second alternative, second aspect or third aspect, the first and second members may be at ambient temperature (i.e. not heated or cooled) when abutted, but typically the method further comprised warming the respective surfaces of the first and second members to a temperature below the melting temperature of the active solder, while the surfaces are abutted. This reduces the amount of heat being conducted away from the joint area allowing solder to flow over the respective surfaces more easily when additional heat is applied using a soldering iron to melt and thermally activate the solder, with or without ultrasonic agitation. For the same reason, the first member and/or second member may be heated when they are being coated as set out in the first alternative and second aspect. In either situation, the warming provided pre-heating of the first and second members. The warming may be achieved by causing hot air to pass over the first and second members.

The mechanical agitation may be provided by any source or process capable of breaking a dross skin of oxide(s) formed on the molten active solder. Typically, mechanical agitation is provided by use of ultrasound to induce mechanical movement in the molten active solder, and preferably, the ultrasound is provided by an ultrasonic soldering iron. Providing mechanical agitation in the form of ultrasound from an ultrasonic source allows the mechanical agitation to be administered simply and without the need for cumbersome mechanical arrangements.

Instead of, or in addition to, mechanical agitation being provided by providing ultrasound, as well as being able to provide mechanical agitation from any source or process capable of breaking a dross skin of oxide(s) formed on the molten active solder, the mechanical agitation provided when the respective surfaces of the first and second members are abutted may be provided at least in part by movement of said respective surfaces against each other. This means that mechanical agitation does not need to be provided by an external source. This allows the abutted surfaces to not be separated to provide mechanical agitation between the abutted surfaces thereby allowing the molten solder coated on each surface to merge at the parts of the respective surfaces in closest proximity to each other. This results in an improved solder joint as the abutted surfaces are kept closer together. Furthermore, this means that no additional equipment is needed to produce the mechanical agitation.

While the movement of the abutted surfaces against each other may be provided in any form able to produce such motion, typically, the movement of said respective surfaces against each other is relative rotational movement. This allows the relative location of each of the first and second members to be kept the same while still providing mechanical agitation.

The active solder contains elements that are able to reduce the oxide layer that forms on the surface of the niobium titanium alloy of the first member. Accordingly, any active solder that is capable of achieving this is suitable to use. Typically however, the active solder is an alloy including tin and at least one of silver, titanium, cerium, gallium and magnesium. A combination of other elements may also be used in addition to, or instead of one or more of silver, titanium, cerium, gallium and magnesium, such as copper or bismuth. Preferably, the active solder is an alloy including tin, silver, titanium, cerium, gallium and magnesium. These combinations of elements in the active solder have been found to be most effective at breaking down the oxides on the surface of a niobium titanium alloy.

The first member may be any item that is made of a niobium titanium alloy that is to be soldered to another item. Typically though, the first member is the core and/or shield of a coaxial cable. This allows coaxial cables in a cryogenic refrigerator, such as a dilution refrigerator, as well as in other applications to be soldered to another member when the core and/or shield is made of a niobium titanium alloy.

While the second member may be any item to which the first item is to be soldered, typically, the second member is a coaxial cable connector. This allows a coaxial cable with a core and/or shield made of a niobium titanium alloy to form a data transmission line with other coaxial cables and/or to connect to a data source or data recorder.

In an example of a signal transmission line, the second member may be a coaxial cable connector. The centre pin of the coaxial cable connector may be copper, beryllium-copper, stainless steel, Kovar or brass. The connector body may be copper, beryllium-copper, stainless steel, brass, a copper tin alloy or any other material suitable for forming an RF coaxial cable connector. Additionally, the second member may also be coated with gold or gold plating over nickel. Other options for the connector are a copper tin alloy with a coating of flash white bronze over silver.

Any metallic material (including difficult to solder materials such as stainless steels or aluminium) or ceramic material is able to be used for the second member using the process of the first aspect.

According to a fourth aspect of the invention, there is provided use of an active solder in forming a solder joint between a two members, at least one member being made of a niobium titanium alloy.

Using an active solder in forming a solder joint between two members, at least one of which is made of a niobium titanium alloy allows strong solder joint to be made between an item made of a niobium titanium alloy to an another. This is because the active solder is able to reduce the oxide layer on the niobium titanium alloy. Accordingly, more reliable solder joints can be formed for such items using an active solder as set out above.

### BRIEF DESCRIPTION OF FIGURES

Examples of a joining method are described in detail below, with reference to the accompanying figures, in which:

FIG. 1 shows a flow chart of an example joining method;

FIG. 2 shows a flow chart of a sub-process of the example joining method of FIG. 1;

FIG. 3 shows a flow chart of a second sub-process of the example joining method of FIG. 1;

FIG. 4 shows a flow chart of a second example joining method; and

FIG. 5 shows a flow chart of an application of the example joining method of FIG. 1.

### DETAILED DESCRIPTION

We now describe two examples of a joining method, along with a description of an example application of one of the example joining methods.

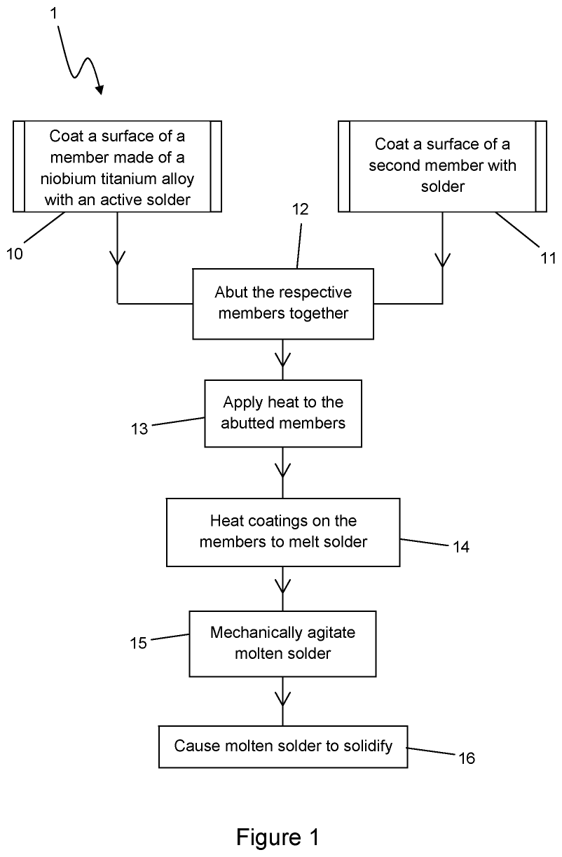

Referring now to FIG. 1, a process of a first example joining method is illustrated generally at 1.

The process illustrated in FIG. 1 is a two-stage process. The first stage of this process is to coat a surface of a first member made of a niobium titanium alloy with an active solder, step 10, and coat a surface of a second member each with a solder, step 11. This is commonly referred to as “tinning”.

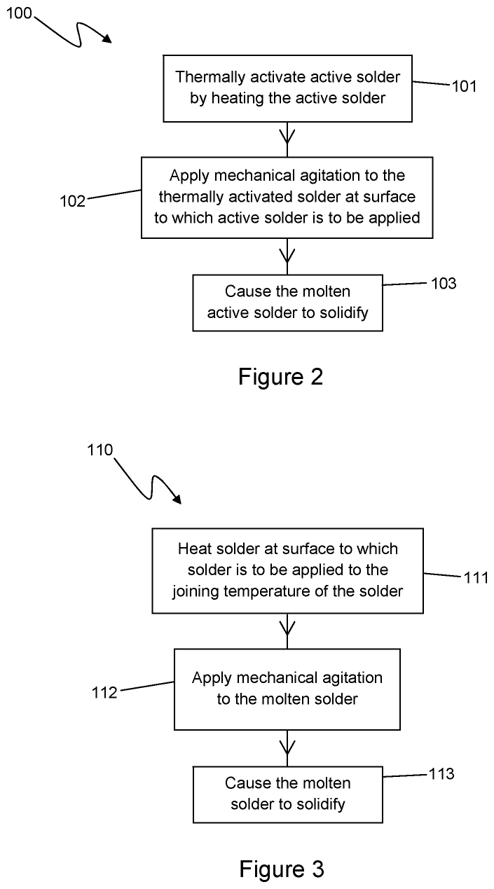

The process carried out to coat the surface of the first member is illustrated generally at 100 in FIG. 2. This process involves heating the active solder to a joining temperature of the active solder, step 101. The joining temperature, which as is explained below, is a higher temperature than the melting temperature of the solder, and is a temperature at which the reactivity of the reactive elements is sufficiently high for them to react with oxides with which the solder comes into contact. This is referred to as thermal activation of the active solder.

When the active solder is molten, the solder and the reactive elements in the solder quickly oxidise on contact with air. The oxidisation of the reactive elements forms a skin around the molten active solder, referred to as “dross”, forming a seal around the molten solder. To break the skin, mechanical agitation is provided to the molten active solder, step 102. This step is carried out at the surface of the first member to which the solder is to be applied. This allows the molten active solder to flow over said surface once the skin is broken.

Since the molten active solder is thermally activated at this point, the active elements in the active solder react with oxides on the surface of the first member in a redox reaction. This reduces the oxides on the surface of the first member leaving un-oxidised surface exposed to the solder. This allows the molten active solder to wet the surface of the first member causing the solder to adhere to said surface.

Once the molten active solder has adhered to the surface of the first member in this manner, the molten active solder is caused to cool, step 103. This is achieved by removing the heat source, which was maintaining the solder at a temperature above its melting temperature. This cause the solder to cool to a temperature beneath is melting temperature thereby causing it to solidify.

The process carried out to coat the surface of the second member is illustrated generally at 110 in FIG. 3. To coat the surface of the second member, a solder is heated at the surface of the second member causing the solder to melt, step 111.

The second member is not intended to be made of a niobium titanium alloy, however, any solder needs to be at about 20 degrees centigrade (° C.) to about 50° C. above its melting point to form a solder joint. This is referred to as the solder's joining temperature. Accordingly, the next step in coating the surface of the second member is to heat the solder to its joining temperature causing the molten solder to flow over said surface of the second member, step 112. As with the corresponding step in the process of coating the surface of the first member, this causes the molten solder to wet the surface of the second member and thereby to adhere to said surface.

The step of mechanically agitating the molten solder need only be carried out when the molten solder used to coat the surface of the second member is an active solder. This is the case in this example, but a non-active solder (i.e. a solder the composition of which does not include active elements) could be used as an alternative solder. Should a non-active solder be used, this step is optional. However, a flux would then be needed for the solder to wet the surface of the second member in place of the active elements of an active solder.

In a further parallel with the process of coating the surface of the first member, the molten solder is then caused to cool, step 113. Again, this is achieved by removing the heat source, which is maintaining the solder at a temperature above its melting temperature, thereby allowing the solder to cool and solidify.

In an alternative example, before the solder is applied to the surface of the second member, or instead of applying the solder to the surface of the second member, tin or a tin alloy is electroplated on to the surface of the second member pre-tinning the surface.

Returning to the joining method illustrated at 1 in FIG. 1, once the respective surfaces of the first member and second member are coated with solder the first stage of the process is complete and the second stage of the process begins. The second stage involves joining the coated surfaces together. This involves a number of steps, the first of which is that the first member and the second member are abutted together, step 12, forming an interface where the first and second members are in contact with the coated surface of each member close to the interface between the first and second members.

Once the first and second members are abutted against each other, heat is applied to the first member and the second member to heat each member to a temperature below the melting temperature of the solder coated on each member, step 13.

The coatings on each of the coated surfaces are then heated further to re-melt the solder, step 14. Depending on the quantity of solder that is coated on the coated surfaces, if it is considered that more solder is needed or would be beneficial, additional molten active solder is applied at the interface between the first and second members (step not shown). In this example, all the solders (the solder coated on each of the first and second members as well as any additional solder) are the same active solder. Should one or more different solders be used however, each solder will need to be miscible or at least compatible with each of the other solders.

However, as is mentioned above, if active solder is used it will not just react with the surface oxides on a niobium titanium alloy, but also with the oxygen in the atmosphere; as a result oxides will have formed on the surface of the solder forming a ‘dross’ skin. Accordingly, mechanical agitation is again applied to the molten solder, step 15. This causes the dross skin to break up allowing (un-oxidised) molten solder on the coated surface of each of the first member and second member to come into contact, merge and form a continuous body of molten solder.

The continuous body of molten solder provides a link between the first member and the second member because the molten solder continues to adhere to the surface of each of the first member and the second member once merged. Once this is achieved, the molten solder is caused to cool again, step 16, solidifying the solder forming a solder joint between the first member and the second member. As with each of the coating processes, this is achieved by removing the heat source thereby causing the solder to cool beneath its melting temperature and solidify.

Should a non-active solder have been used to coat the surface of the second member, as mentioned above, a flux will be used. Accordingly, an additional step of removing any flux residue will be needed before mechanical agitation is applied to the molten active solder. This will avoid the flux residue being present in the continuous body of molten solder and potentially weakening the resulting solder joint.

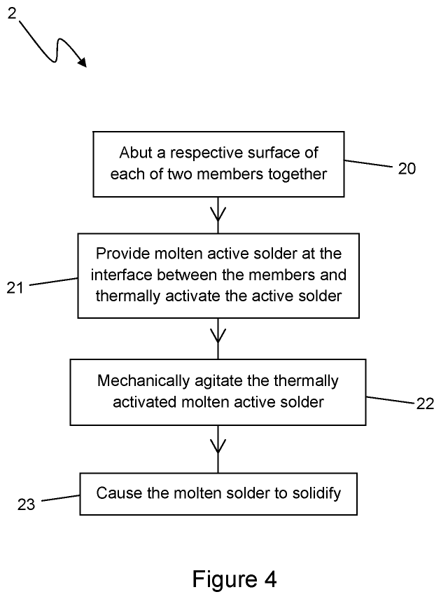

The process illustrated in FIG. 1 is a two-stage process because the surfaces of the respective members are tinned and then joined. Referring now to FIG. 4, a process of a second example joining method is illustrated generally at 2. Instead of a two-stage process, such as the process illustrated in FIG. 1, the process illustrated in FIG. 4 is a one-stage process.

Generally speaking, the process illustrated in FIG. 4 is a one-stage process because the whole process is able to be carried out in a single joining process. This is instead of any component that is involved in the process being pre-prepared as is the case in the process illustrated in FIG. 1 with the tinning of the surfaces of the respective members.

Turning to the details of the process illustrated in FIG. 4, a surface of a first member made of a niobium titanium alloy and a surface of a second member are abutted together, step 20. This provides an interface between the first and second members. A molten active solder is then provided at said interface and heated to its joining temperature so as to thermally activate the molten active solder, step 21.

By providing the molten active solder at the interface, it is intended to mean either, that the molten active solder is provided within the interface, i.e. between the surfaces of the first and second members that are in contact, or that the molten active solder is provided at least one location on the perimeter of the interface between the first and second members.

Once the molten active solder is thermally activated, the thermally activated molten solder is mechanically agitated, step 22. This causes the dross skin, which forms on the solder as the active elements oxidise when the active solder is heated, to break. When the skin breaks, the molten active solder flows over each of the first and second members. This causes the solder to wet a surface of the second member over which it is flowing. Since the molten active solder is thermally activated, the molten active solder also wets a surface of the first member over which it is flowing by the same process as described above in relation to the process illustrated in FIG. 2. The mechanical agitation also causes the molten active solder to flow into the interface between the first member and the second member when the molten active solder has only been provided at the perimeter of the interface between the first and second members.

This results in the molten active solder adhering to the each of the first and second members and forming a continuous body of molten solder thereby linking the first member and the second member. Once the continuous body of molten solder is formed, the molten solder is caused to cool, step 23. This is achieved by removing the heat source that is maintaining the molten active solder at a temperature above its melting temperature. This forms a solder joint between the first member and the second member once the active solder has solidified.

Example Application of a Joining Method

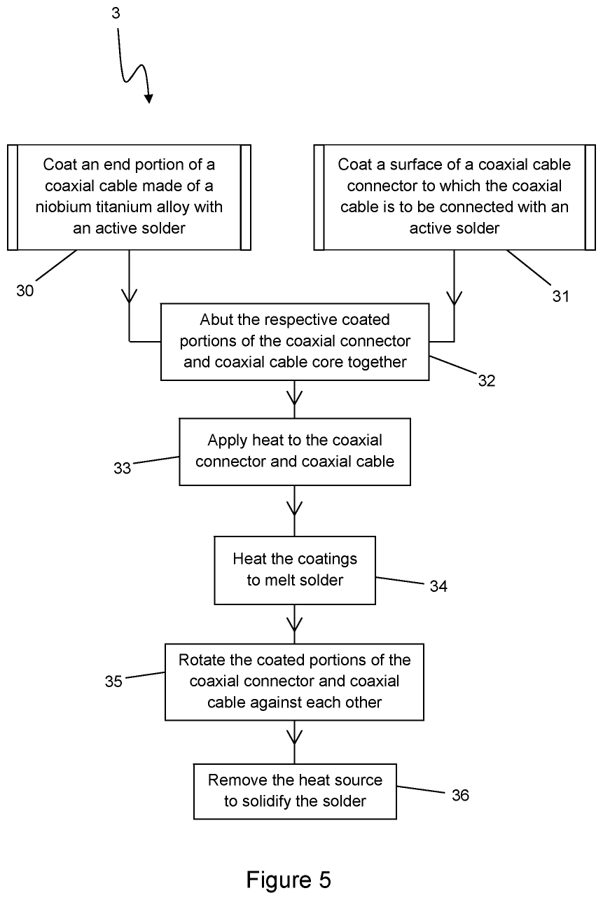

Referring now to FIG. 5, an example application of forming a solder joint between a first member made of a niobium titanium alloy and a second member is generally illustrated at 3.

First however, details of the coaxial cable are provided. The coaxial cable has a standard structure in that it has a centre conductor or core, around which a dielectric material is provided. An outer jacket or shield is provided around the dielectric material. As mentioned above, the core and the shield are each made of a niobium titanium alloy. A typical dielectric material is polytetrafluoroethylene (commonly abbreviated to as “PTFE”) but other dielectric materials, such as polyether ether ketone (PEEK) and liquid crystalline polymer (LCP) can also be used.

The process illustrated in FIG. 5 is directed at forming a solder joint between the centre conductor of the coaxial cable and the centre pin of the connector and in a second step a solder joint is formed between the outer jacket of the coaxial cable and the connector body of the coaxial connector.

In one embodiment the outer diameter of the coaxial cable is about 1.195 millimetres (mm), the outer diameter of the PTFE dielectric is about 0.940 mm and the centre conductor outer diameter is about 0.287 mm. Other diameters of coax cables are available, which are governed by international standards. The process described here is equally applicable for other diameters of coaxial cables.

Turning to the coaxial connector, this is a standard RF coaxial connector of an appropriate size to connect with the coaxial cable. The coaxial connector used in this example is made of a gold plated beryllium copper alloy.

Returning to the processing of forming a solder joint between the centre conductor and shield of the coaxial cable and the coaxial connector, the first stage of this process is to coat an end portion of the coaxial cable core and shield with an active solder, step 30, and coat a surface of the connector pin and outer body of the coaxial connector with the active solder, step 31. Coating each of the end portions of the core and shield of the coaxial cable and the surface of the coaxial connector is a tinning process.

The active solder that is used in this example is made of an alloy including tin, silver, titanium, cerium, gallium and magnesium. The particular active solder used is active solder 220M produced by S-Bond Technologies, whose website can be accessed at: http://www.s-bond.com/.

The tinning process used to coat each of the core and shield of the coaxial cable with the active solder is the process illustrated in FIG. 2 and described above. Accordingly, to coat each of the core and shield of the coaxial cable, the active solder is heated above its melting point to its joining temperature to thermally activate the solder using a soldering iron. For active solder 220M, this is about 20° C. to 50° C. above the melting temperature (by this we intend to mean the joining temperature which is 20° C. to 50° C. above the “liquidus temperature”) of the solder.

For reference, the S-Bond active solder 220M has a solidus temperature (which we intend to mean the highest temperature at which the active solder is completely solid) of about 221° C., a liquidus temperature of about 232° C. and a joining temperature (i.e a temperature at which the active solder is capable of joining members together) range from about 250° C. to about 280° C. Between the solidus temperature and the liquidus temperature, the solder is partially solid and partially liquid (i.e. molten).

To protect the PTFE and reduce the possibility of melting the PTFE dielectric material, the length of time the solder is molten is minimised. PTFE has a melting temperature of about 327° C. and a maximum operating temperature of about 260° C. To minimise the amount of time the PTFE is subject to elevated temperatures the heat applied for the solder process is split between the solder process for the core and the shield of the coaxial cable.

When the active solder is thermally activated (and therefore molten), to coat the solder on to the respective component of the coaxial cable, the thermally activated molten active solder is mechanically agitated at an end portion of each respective component. At this stage, the mechanical agitation is generated by ultrasound produced by the soldering iron, which is an ultrasonic soldering iron. As explained above, this causes the dross skin on the molten active solder to break allowing the solder to flow over and adhere to the component by reducing the oxide layer on the surface of the component and wetting the surface of the component. The soldering iron is then removed allowing the active solder to cool and solidify.

Solder is coated on to the surface of the coaxial connector by the same process as the solder is coated on to the core and shield of the coaxial cable. However, since the coaxial connector is not made of a niobium titanium alloy but typically has a surface layer which is designed to allow it to be easily wetted, coating the connector with active solder is much easier although mechanical agitation is recommended. Accordingly, the surface of the coaxial connector is coated using the process illustrated in FIG. 3 and described above. As such, the active solder is melted using a soldering iron. Mechanical agitation, again, in the form of ultrasound produced by the soldering iron is then applied to the solder at the surface of the coaxial connector causing the molten solder to flow over and adhere to the surface of the coaxial connector by wetting the surface. Once this has occurred, the soldering iron is removed, which allows the solder to cool and solidify.

As an alternative to using active solder to coat the connector, because the connector is not made of niobium titanium alloy, a non-active, i.e. standard, solder can be used instead of an active solder. In this alternative, the standard solder is a flux cored solder. This is applied to the connector through a standard procedure for coating or pre-tinning a surface, such as by heating the surface to which the solder is to be applied using a soldering iron and providing the solder at the heated surface. This causes the solder to become molten and flow on to the heated surface. The soldering iron can then be removed to allow the molten solder to solidify on the surface to which it has been applied. When a solder with flux is used to tin the surface of the coaxial connector, any excess flux is removed by cleaning the coated surface.

We have found that the final solder joint appears smoother when using a combination of active solder on the niobium titanium alloy and a non-active solder on the coaxial connector. However, we have found no differences between the qualities of the final solder joints.

Once the coaxial cable and coaxial connector are coated with solder, the first stage of the process of FIG. 5 is complete. The second stage of the process of joining the coaxial cable and coaxial connector is achieved by first mounting the centre pin of the coaxial connector and second the connector body in a rotatable clamp.

In a first step, the centre pin of the coaxial connector is soldered to the centre conductor of the coaxial cable, the coaxial cable having been suitably prepared in advance. Solder is applied to the centre pin as explained above, then the centre pin of the coaxial connector is mounted into a rotating clamp. The end of the coaxial cable at which the core and shield have been tinned is guided into the centre pin of the coaxial connector causing the surface of the coaxial connector pin and the core of the coaxial cable to abut together, step 32. A hot air gun is then used to warm the core of the coaxial cable and the pin of the coaxial connector, step 33. As noted above, the warming does not raise the temperature of the components above the melting temperature of the solder on either the coaxial cable or the coaxial connector.

When the centre pin of the coaxial connector and the centre conductor of the coaxial cable are pre-heated, while continuing to use the hot air gun on each of the components, the solder(s) is/are melted using a soldering iron, step 34.

As an alternative to heating the solder(s) with a soldering iron, it is possible to heat the coaxial cable and/or coaxial connector using resistive soldering techniques. To achieve this, a conductive contact, such as a pair of conductive tweezers, is placed against the coaxial cable and/or coaxial connector. This forms an electrically conductive connection to the cable and/or connector. A current is then passed from the conductive contact into the cable and connector. This causes heat to be generated in the cable and connector through resistive heating. A rapid rise in temperature occurs due to the resistive heating raising the temperature of the surface of each of the coaxial cable shield and core and coaxial connector above the melting point of the solder coating on each component. This occurs within a short period of time, such as within a few seconds, for example in less than ten seconds or in less than five seconds. Once the solder coatings are molten the resistive heating can optionally be stopped by no longer applying a current through the components. By applying such a rapid increase in temperature and then removing the source of heating, we have found that there is a reduced likelihood of the joint formed between the active solder and the surfaces of the coaxial cable on to which it is coated failing due to the limited period that joint is exposure to raised temperatures.

Once the solder coatings are melted, the rotatable clamp is rotated causing rotation of the coaxial connector pin relative to the coaxial cable, step 35. Due to the surfaces of the inner diameter of the centre pin of the coaxial connector and outer diameter of the centre conductor of the coaxial cable being abutted, the relative rotation of the components causes mechanical agitation in the molten solder and disruption of oxide layers on the niobium titanium and causing the breakup of the dross skin of the molten solder. Extra mechanical agitation is able to be applied to the molten solder in the form of ultrasound produced by the soldering iron (which is an ultrasonic soldering iron) in addition to the mechanical agitation caused by the rotation of the coaxial connector relative to the coaxial cable or if the mechanical agitation caused by the rotation of the coaxial connector relative to the coaxial cable is insufficient to break the dross skin on one or each of the components. The breakup of the dross skin causes the molten solder coated on the pin of the coaxial connector and outer diameter of the centre conductor to merge, forming a continuous body of molten solder.

Once the continuous body of molten active solder is formed, the rotation of the rotatable clamp is stopped and the soldering iron is removed, step 36. This causes the solder to cool and solidify thereby forming a solder joint between the coaxial cable and the coaxial connector.

In the second step, in order to complete the coax assembly, the coaxial connector body is mounted in the rotating clamp. The sub-assembly of the centre pin of the coaxial connector which is soldered to the centre conductor of the coaxial cable is then inserted into a connector bore of the coaxial connector body in a suitable manner (this usually being as set out by in instructions for the coaxial connector body provided by the supplied) until an “end stop” in the connector bore.

The inside of the bore of the connector body is coated with active solder in accordance with the techniques described above, or if standard solder is used and flux was applied to ensure good wetting of the surfaces, the flux has to be removed. The outer conductor of the coaxial cable is then soldered to the connector body as described above in relation to forming the joint between the centre pin of the connector and the centre conductor of the coaxial cable.

As set out above, the core and shield of the coaxial cable are made of niobium titanium alloy. The alloy is used without also using a matrix or carrier of another material such as copper or a copper nickel alloy.

Also as set out above, while the first member is made of niobium titanium alloy, which is superconducting at cryogenic temperatures, the second member (corresponding to the coaxial connector in the example above) is made from a material that is non-superconducting at cryogenic temperatures (for example at temperatures between about 77 K and about 4 K). Accordingly, only one of the first and second members is superconducting. However, in the examples described herein, each of the first and second members is a metal or metal alloy.

1-23. (canceled)

24. A method of joining a first member made of a niobium titanium alloy to a second member, the method comprising:
abutting a respective surface of each of the first member and the second member together to form an interface therebetween;
providing a molten active solder at a surface of at least the first member at the interface and thermally activating the molten active solder;
mechanically agitating the molten active solder so as to cause the molten solder to adhere to the first and second members and form a continuous body of molten solder linking the first and second; and
causing the continuous body to solidify thereby forming a solder joint between the first and second members.

25. The method according to claim 24, wherein the molten active solder is provided at the surface of at least the first member and thermally activated before the respective surfaces of each of the first and second member are abutted together, the thermally activated molten solder being mechanical agitated at the surface of the first member so as to cause the active solder to adhere to the surface of the first member thereby providing a coated surface of the first member.

26. The method according to claim 25, further comprising causing the molten active solder to solidify between providing the coated surface of the first member and abutting the respective surfaces of each of the first and second members, and re-melting the active solder after abutting said respective surfaces.

27. The method according to claim 25, wherein further molten active solder is provided at the respective surfaces of the first and second members when said surfaces are abutted.

28. The method according to claim 25, further comprises coating a surface of the second member with tin or a tin solder alloy.

29. The method according to claim 28, wherein coating the surface of the second member with tin or a tin solder alloy comprises electroplating the surface of the second member with tin or tin solder alloy or comprises providing molten tin or tin solder alloy at the surface of the second member.

30. The method according to claim 25, further comprising providing molten active solder at the surface of the second member and mechanically agitating the molten solder so as to cause the solder to adhere to the surface of second member thereby providing a coated surface of the second member.

31. The method according to claim 30, wherein the active solder provided as molten solder at the surface of the second member is the same active solder as the active solder coated on the surface of the first member, and/or further comprising causing the molten solder provided at the surface of the second member to solidify between the step of providing the coated surface of the second member and the step of abutting the respective surfaces of each of the first and second members, and re-melting the second solder after abutting said respective surfaces.

32. The method according to claim 24, further comprising warming the respective surfaces of the first and second members to a temperature below the melting temperature of the active solder while the surfaces are abutted.

33. The method according to claim 24, wherein mechanical agitation is provided by use of ultrasound to induce mechanical movement in the molten active solder.

34. The method according to claim 24, wherein the mechanical agitation provided when the respective surfaces of the first and second members are abutted is provided at least in part by movement of said respective surfaces against each other.

35. The method according to claim 34, wherein the movement of said respective surfaces against each other is relative rotational movement.

36. The method according to claim 24, wherein the active solder is an alloy including tin and at least one of silver, titanium, cerium, gallium and magnesium.

37. The method according to claim 24, wherein the providing of the molten active solder and thermally activating the molten active solder at the surface of at least the first member is performed after the respective surfaces of each of the first member and second member are abutted together thereby providing the molten active solder and thermal activation of the molten active solder at the interface of the first and second members.

38. A method of joining a first member made of a niobium titanium alloy to a second member, the method comprising:
providing a thermally activated molten active solder at a surface of the first member and mechanically agitating the thermally activated active solder so as to cause the active solder to adhere to the surface of first member thereby providing a coated surface of the first member;
abutting the first member and the second member together and mechanically agitating the molten active solder causing the molten active solder to adhere to a surface of the second member so as to form a continuous body of molten solder linking the surfaces of the first and second members; and
causing the continuous body to solidify thereby forming a solder joint between the first and second members.

39. The method according to claim 38, further comprising causing the molten active solder to solidify between providing the coated surface of the first member and abutting the respective surfaces of each of the first and second members, and re-melting the active solder after abutting said respective surfaces.

40. The method according to claim 38, wherein further molten active solder is provided at the respective surfaces of the first and second members when said surfaces are abutted.

41. The method according to claim 38, further comprising coating a surface of the second member with tin or a tin solder alloy.

42. The method according to claim 41, wherein coating the surface of the second member with tin or a tin solder alloy comprises electroplating the surface of the second member with tin or tin solder alloy or comprises providing molten tin or tin solder alloy at the surface of the second member.

43. The method according to claim 38, further comprising providing molten active solder at the surface of the second member and mechanically agitating the molten solder so as to cause the solder to adhere to the surface of second member thereby providing a coated surface of the second member.

44. The method according to claim 43, wherein the active solder provided as molten solder at the surface of the second member is the same active solder as the active solder coated on the surface of the first member and/or further comprising causing the molten solder provided at the surface of the second member to solidify between the step of providing the coated surface of the second member and the step of abutting the respective surfaces of each of the first and second members, and re-melting the second solder after abutting said respective surfaces.

45. The method according to claim 38, further comprising warming the respective surfaces of the first and second members to a temperature below the melting temperature of the active solder while the surfaces are abutted.

46. The method according to claim 38, wherein mechanical agitation is provided by use of ultrasound to induce mechanical movement in the molten active solder.

47. The method according to claim 38, wherein the mechanical agitation provided when the respective surfaces of the first and second members are abutted is provided at least in part by movement of said respective surfaces against each other.

48. The method according to claim 47, wherein the movement of said respective surfaces against each other is relative rotational movement.

49. The method according to claim 38, wherein the active solder is an alloy including tin and at least one of silver, titanium, cerium, gallium and magnesium.

50. A method of joining a first member made of a niobium titanium alloy to a second member, the method comprising:
abutting the first member and the second member together to form an interface therebetween;
providing a molten active solder at the interface of the first and second members and thermally activating the molten active solder;
mechanically agitating the thermally activated molten active solder causing the molten solder to adhere to the first and second members and form a continuous body of molten solder linking the first and second members; and
causing the continuous body to solidify thereby forming a solder joint between the first and second members.

51. The method according to claim 50, further comprising warming the respective surfaces of the first and second members to a temperature below the melting temperature of the active solder while the surfaces are abutted.

52. The method according to claim 50, wherein mechanical agitation is provided by use of ultrasound to induce mechanical movement in the molten active solder.

53. The method according to claim 50, wherein the mechanical agitation provided when the respective surfaces of the first and second members are abutted is provided at least in part by movement of said respective surfaces against each other.

54. The method according to claim 53, wherein the movement of said respective surfaces against each other is relative rotational movement.

55. The method according to claim 50, wherein the active solder is an alloy including tin and at least one of silver, titanium, cerium, gallium and magnesium.

56. Use of an active solder in forming a solder joint between a two members, at least one member being made of a niobium titanium alloy.

57. The active solder according to claim 56, wherein the active solder is an alloy including tin and silver and at least one of titanium, cerium, gallium and magnesium.
